(19) United States
(12) Patent Application Publication
(10) Pub. No.: US 2025/0333116 A1
(43) Pub. Date: Oct. 30, 2025

(54) VEHICLE BODY

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 19/024,796

(22) Filed: Jan. 16, 2025

(30) Foreign Application Priority Data
Apr. 24, 2024 (JP) 2024-070769

(51) Int. Cl. B62D 25/14; B62D 25/04; B62D 29/00

(52) U.S. Cl. CPC B62D 25/14; B62D 25/04; B62D 29/008

(57) ABSTRACT

The vehicle body comprises a vehicle body component that is a metal casting. The vehicle body component includes an upper component portion that extends in the vehicle width direction and supports the windshield glass, a lower component portion that extends in the vehicle width direction and supports the floor portion, a pair of side components that are attached to the suspension support portion, constitute a part of the front pillar on a vehicle lower side and that connect the upper component portion and the lower component portion, and a partition wall portion that is integrated with the upper component portion, the lower component portion, and the side component portion and partitions the vehicle cabin and the power unit room.

### CROSS-REFERENCE TO RELATED APPLICATION

This application claims priority to Japanese Patent Application No. 2024-070769 filed on Apr. 24, 2024, incorporated herein by reference in its entirety.

### BACKGROUND

### 1. Technical Field

The present disclosure relates to a vehicle body.

### 2. Description of Related Art

Japanese Unexamined Patent Application Publication No. 2022-166936 (JP 2022-166936 A) discloses a disclosure related to a front body structure of a vehicle. The front body structure of a vehicle includes a suspension housing that is an aluminum alloy cast product. Accordingly, in the prior art, the number of components can be reduced compared to a configuration in which a plurality of members is joined by welding to form a suspension housing.

### SUMMARY

In the prior art, a damper that constitutes a part of the suspension is attached to the suspension housing. However, since an attachment position of the suspension varies in accordance with the specifications or the like of the vehicle, in the prior art, there is room for improvement from the viewpoint of commonalization of components that constitute the vehicle body.

The present disclosure provides a vehicle body that can reduce the number of components that constitute the vehicle body and can perform commonalization of the components that constitute the vehicle body.

A vehicle body relating to a first aspect includes
a vehicle body component being a metal casting, in which
the vehicle body component includes
an upper component portion that extends in a vehicle width direction and supports a windshield glass,
a lower component portion that extends in the vehicle width direction and is arranged along a front edge of a floor portion to support the floor portion,
a pair of side component portions that constitutes a part of a front pillar on a vehicle lower side, the side component portions connecting the upper component portion and the lower component portion, and being each provided with a suspension support portion that supports a part of a suspension, and
a partition wall portion integrated with the upper component portion, the lower component portion, and each of the side component portions, the partition wall portion partitioning a vehicle cabin and a power unit room.

According to the vehicle body relating to the first aspect, the vehicle body component of the vehicle body includes an upper component portion that extends in a vehicle width direction and a lower component portion that extends in the vehicle width direction. Moreover, the vehicle body component includes a pair of side component portions that each connect the upper component portion and the lower component portion, and a partition wall portion integrated with the upper component, the lower component, and each of the side components.

In vehicles of various specifications, the shape of the windshield glass tends to have a similar shape, and the shape of the portion that supports the windshield glass in the vehicle body tends to be similar. Moreover, in vehicles of various specifications, while the height or the like of the floor portion of the vehicle body tends to be different, a correlation relationship between the floor portion in the vehicle body and the portion that supports the floor portion tends to be similar. Moreover, in vehicles of various specifications, while the overall configuration of the front pillar tends to be different, the configuration of the portion on the vehicle lower side of the front pillar tends to be similar. In addition, in vehicles of various specifications, the configuration of a partition wall that partitions the vehicle cabin and the power unit room tends to be similar.

Here, in the present aspect, the upper component portion can support the windshield glass, the lower component portion can be arranged along a front edge of the floor portion to support the floor portion, the side component portions each constitute a part of a front pillar on a vehicle lower side, and the vehicle cabin and the power unit room are partitioned by the partition wall portion. Moreover, a suspension support portion that supports a part of the suspension is attached to each of the side component portions, the suspension tending to have an attachment position that varies in accordance with the specifications or the like of the vehicle.

Namely, in the present aspect, in vehicles of various specifications, the portions that can be commonalized in the vehicle body are integrated into the vehicle body component. Moreover, in vehicles of various specifications, components that are difficult to commonalize in the vehicle body are separated from the vehicle body component and attached to the vehicle body component.

Moreover, in the present aspect, the vehicle body component is a metal cast product, and the upper component portion, the lower component portion, each of the side component portions, and the partition wall portion can be configured as one component. Accordingly, the number of components that constitute the vehicle body component can be reduced compared to a configuration in which the vehicle body component is constituted by having the components formed of steel plates and welded.

A vehicle body relating to a second aspect in which, in the vehicle body relating to the first aspect,
a penetration portion penetrated in a vehicle front-rear direction is formed on the partition wall portion, and the penetration portion is blocked by a dash panel component, and
a part of a brake device is attached to the dash panel component.

According to the vehicle body relating to the second aspect, as described, the vehicle body component includes a partition wall portion that partitions the vehicle cabin and the power unit room. The partition wall portion is positioned in the vicinity of the driver's seat. Also, it can be considered that a part of a brake device is attached, for example, to the partition wall portion.

The attachment position of the brake device tends to vary in accordance with the specifications of the vehicle. When a configuration is adopted in which a part of the brake device is directly attached to the partition wall portion, a plurality of attachment portions of the brake device must be set in the partition wall portion so as to correspond to the attachment position of the brake device in accordance with the specifications of the vehicle.

Here, in the present aspect, a penetration portion penetrated in a vehicle front-rear direction is formed on the partition wall portion, and the penetration portion is blocked by a dash panel component. Also, a part of a brake device is attached to the dash panel component.

Accordingly, in the present aspect, the dash panel component provided with an attachment portion corresponding to the attachment position of the brake device is attached to the partition wall portion, in accordance with the specifications of the vehicle. In this way, a part of the brake device can be attached to the vehicle body component, without changing the shape of the vehicle body component.

A vehicle body relating to a third aspect in which, in the vehicle body relating to the second aspect, the dash panel component is made of resin.

According to the vehicle body of the third aspect, the dash panel component is made of resin. Therefore, it is possible to correspond to a change of the attachment position of the brake device in the vehicle, by adjusting a resin mold used for the manufacture of the dash panel component.

A vehicle body relating to a fourth aspect in which, in the vehicle body relating to the first aspect,
the vehicle body includes a front-rear direction skeleton portion that extends in the vehicle front-rear direction and is attached at a vehicle lower side of the suspension support portion with respect to a front surface of the partition wall portion on a vehicle front side, and
a reinforcing rib portion is formed on a back surface of the partition wall portion on a vehicle rear side, the reinforcing rib portion protruding from the back surface to the vehicle rear side and extending from the front-rear direction skeleton portion when viewed from the vehicle front-rear direction.

According to the vehicle body relating to the fourth aspect, the vehicle body includes a front-rear direction skeleton portion that extends in the vehicle front-rear direction and is attached with respect to a front surface of the partition wall portion on a vehicle front side. A part of the skeleton of the vehicle body on the vehicle front side is constituted by the front-rear direction skeleton portion. Moreover, the front-rear direction skeleton portion is positioned on the vehicle lower side of the suspension support portion and can support the suspension support portion.

Incidentally, it can be considered that vibrations are generated in the partition wall portion, by vibrations from the suspension side being input to the partition wall portion via the suspension support portion and the front-rear direction skeleton portion.

Here, in the present aspect, a reinforcing rib portion is formed on a back surface of the partition wall portion on a vehicle rear side. The reinforcing rib portion is in a state that protrudes from the back surface of the partition wall portion to the vehicle rear side and extends from the front-rear direction skeleton portion when viewed from the vehicle front-rear direction. Accordingly, in the present aspect, rigidity of the partition wall portion with respect to various vibrations in the reinforcing rib portion can be secured, and the partition wall portion being vibrated by vibrations from the suspension side can be suppressed.

As explained, a vehicle body relating to the present disclosure has an excellent effect that can reduce the number of components that constitute the vehicle body and can perform commonalization of the components that constitute the vehicle body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a configuration of a part of a vehicle front side in a vehicle body according to the present embodiment;

FIG. 2 is a plan view schematically showing a configuration of a part of a vehicle front side in the vehicle body according to the present embodiment;

FIG. 3 is a side view schematically showing a configuration of a part of a vehicle front side in the vehicle body according to the present embodiment;

FIG. 4 is a rear view schematically illustrating a configuration of a front side of a vehicle in the vehicle body according to the present embodiment; and

FIG. 5 is a cross-sectional view schematically showing a configuration around the front side member in the vehicle body according to the present embodiment (a cross-sectional view taken along line 5-5 of FIG. 3).

### DETAILED DESCRIPTION OF EMBODIMENTS

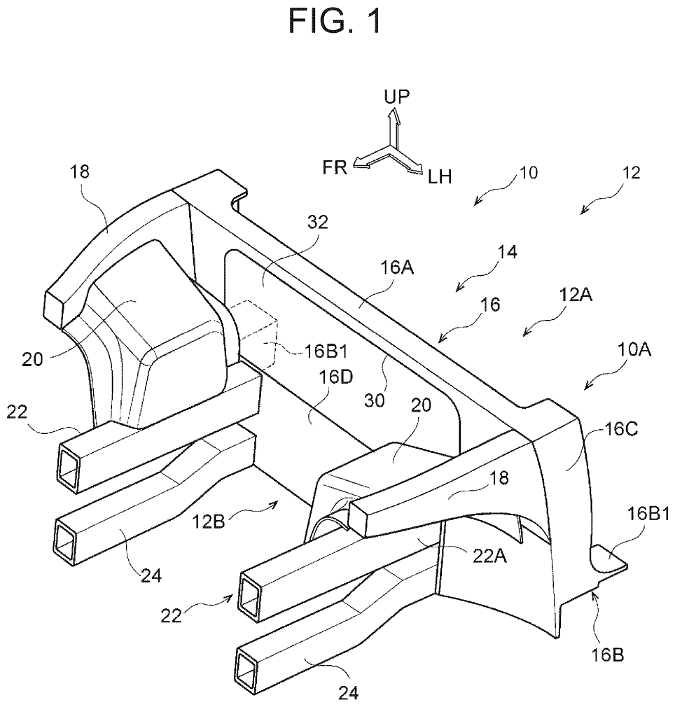

Hereinafter, an example of an embodiment of a vehicle body according to the present disclosure will be described with reference to FIG. 1 to FIG. 5. Note that an arrow FR appropriately shown in the drawings indicates the front side of the vehicle, an arrow UP indicates the upper side of the vehicle, and an arrow LH indicates the vehicle width direction left side.

First, a schematic configuration of the “vehicle 12” including the “vehicle body 10” according to the present embodiment will be described with reference to FIG. 1.

The vehicle body 10 includes a front part 14 that constitutes a part of the vehicle front side. The vehicle body 10 includes a center part (not shown) that constitutes a central portion in the vehicle front-rear direction and includes a battery and a battery frame that holds the battery. The vehicle body 10 includes a rear part (not shown) made of aluminum die cast, which constitutes a part on the rear side of the vehicle. That is, the vehicles 12 are battery electric vehicle. Note that the vehicle body 10 basically has a symmetrical configuration, and the following description will focus on the configuration of a portion of the vehicle body 10 on the left side in the vehicle width direction.

The front part 14 includes a “vehicle body component 16” which constitutes a part on the rear side of the vehicle and is made of aluminum die cast, and a pair of apron upper members 18. The front part 14 includes a pair of “suspension towers 20” serving as suspension support portions, a pair of “front side members 22” serving as front-rear direction skeleton portions, and a pair of suspension side rails 24.

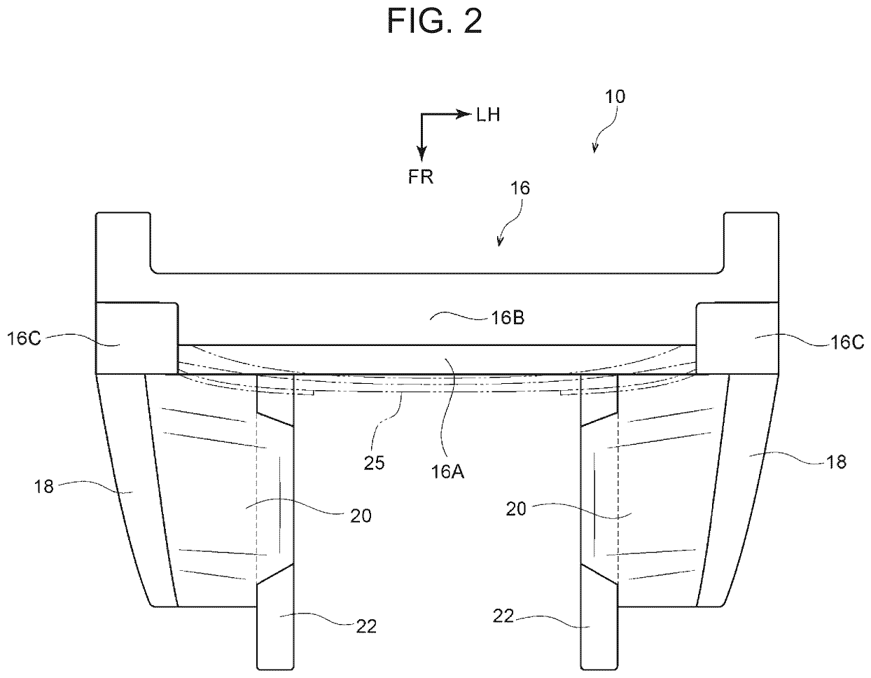

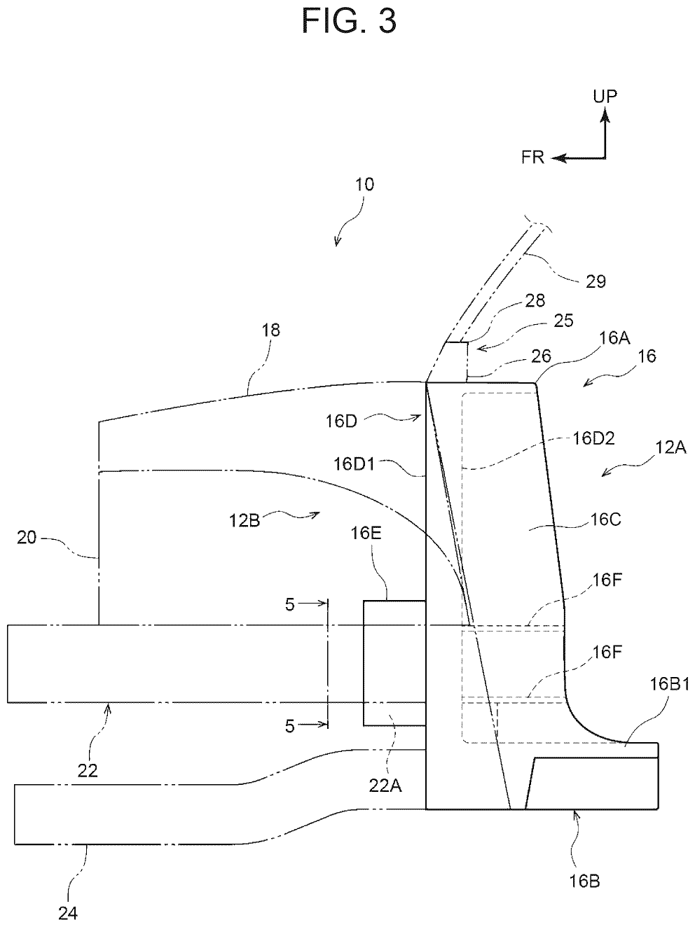

Specifically, the vehicle body component 16 includes, as also shown in FIG. 2 and FIG. 3, an “upper component portion 16A” that constitutes a portion on the vehicle upper side, and a “lower component portion 16B” that constitutes a portion on the vehicle lower side. The vehicle body component 16 includes a pair of “side component 16C” constituting a vehicle width direction outer part thereof, and a “partition wall portion 16D” integrally provided with the upper component portion 16A, the lower component portion 16B, and the side component portion 16C.

The upper component portion 16A extends in the vehicle width direction, and a cowl portion 25 is disposed on the vehicle upper side. The cowl portion 25 extends in the vehicle width direction. The cowl portion 25 includes a cowl lower panel 26 that constitutes a portion on the vehicle lower side, and a cowl top panel 28 that constitutes a portion on the vehicle upper side. The cowl portion 25 is attached to the upper component portion 16A by an attachment member (not shown), and supports the “windshield glass 29” from the lower side of the vehicle.

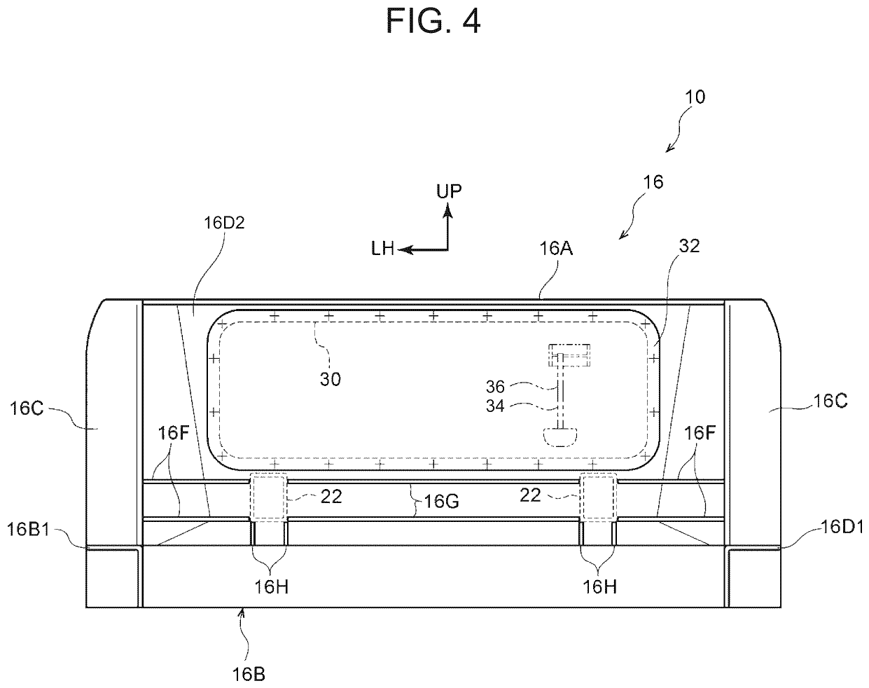

The lower component portion 16B extends in the vehicle width direction, and is disposed along a front edge of a floor portion (not shown) in which a main part of the center part of the vehicle body 10 is configured. Further, as also shown in FIG. 4, attachment piece portions 16B1 are respectively provided at the vehicle width direction outer end portions of the lower component portions 16B. A floor portion of the vehicle body 10 is attached to the attachment piece portion 16B1 via an attachment member (not shown).

The side component portion 16C extends in the vehicle up-down direction and constitutes a part of the vehicle lower side of the “front pillar 10A” of the vehicle body 10. The side component portion 16C connects the upper component portion 16A and the lower component portion 16B vertically. An apron upper member 18 is disposed on the front side of the side component portion 16C.

The apron upper member 18 is formed by joining a plurality of pressed steel plates at a joining portion (not shown) by welding or the like. The apron upper member 18 extends in the vehicle front-rear direction and extends in the vehicle front side from a portion on the vehicle upper side of the side component portion 16C. Further, the side component portion 16C is provided with a plurality of female threads. The apron upper member 18 is fixed to the side component portion 16C via a fixing member (not shown) fastened to the female screw portion. A suspension tower 20 is disposed inside the apron upper member 18 in the vehicle width direction.

The suspension tower 20 has a box shape in which the lower side of the vehicle is opened by joining a plurality of pressed steel plates at a joining portion (not shown) by welding or the like. An end portion of a damper of a shock absorber (not shown) is attached to a top surface portion of the suspension tower 20. The apron upper member 18 is provided with a plurality of female threads, and the suspension tower 20 is fixed to the apron upper member 18 via a fixing member (not shown) fastened to the female threads. That is, the suspension tower 20 is attached to the side component portion 16C via the apron upper member 18.

Returning to FIG. 1, the partition wall portion 16D has a plate shape in which the plate thickness direction is the vehicle front-rear direction and extends in the vehicle widthwise direction and the vehicle up-down direction. The partition wall portion 16D partitions the “vehicle cabin 12A” and the “power unit room 12B” of the vehicles 12. In addition, the partition wall portion 16D is formed with a “penetration portion 30” having a rounded square shape that is penetrated in the vehicle front-rear direction and whose longitudinal direction is the vehicle widthwise direction when viewed from the vehicle front-rear direction.

The penetration portion 30 is closed from the rear side of the vehicle by a resin “dash panel component 32” formed in a plate shape extending in the vehicle width direction and the vehicle vertical direction with the plate thickness direction being the vehicle front-rear direction.

The dash panel component 32 is attached to the partition wall portion 16D by an attachment member (not shown). That is, in the present embodiment, the main part of the dash panel 10B of the vehicle body 10 is constituted by the partition wall portion 16D and the dash panel component 32. A brake pedal 36 constituting a part of the “brake device 34” is attached to the dash panel component 32.

On the other hand, a pair of front side members 22 are disposed in the vehicle lower part of the penetration portion 30 on the “front 16D1” of the vehicle front side of the partition wall portion 16D. The front side members 22 are each formed into an extruded product of an aluminum alloy and have a rectangular tubular shape extending in the vehicle front-rear direction, and are spaced apart from each other in the vehicle width direction. The rear-side end portion 22A of the front side member 22 is attached to the partition wall portion 16D.

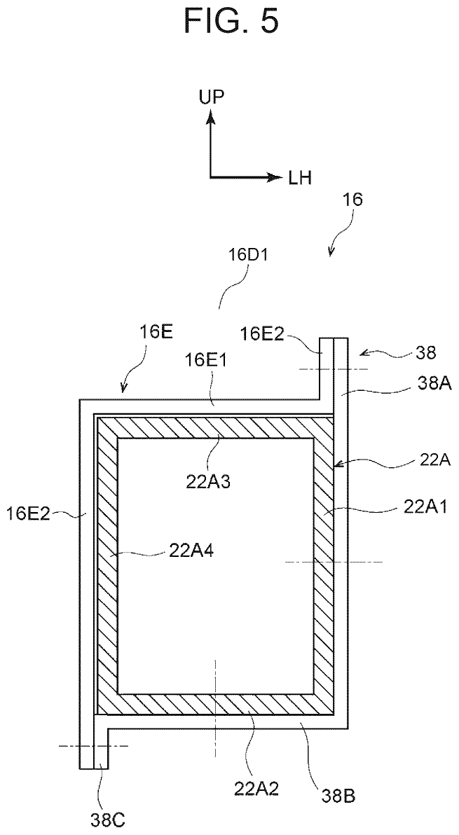

Specifically, as shown in FIG. 5, a pop nut (not shown) is provided on the inner peripheral side of the front side member 22 in the vehicle width direction outer side wall portion 22A1 and the vehicle lower side lower wall portion 22A2 on the end portion 22A of the front side member 22, respectively. A mounting plate 38 is attached to the end portion 22A of the front side member 22 using these pop nuts.

The mounting plate 38 extends vertically along the side wall portion 22A1. The mounting plate 38 includes a vertical piece portion 38A partially extending above the front side member 22. The mounting plate 38 includes a lateral piece portion 38B extending inward in the vehicle width direction along the lower wall portion 22A2 from the peripheral edge portion on the vehicle lower side of the vertical piece portion 38A, and a flange portion 38C extending downward in the vehicle from the peripheral edge portion on the vehicle width direction inner side of the lateral piece portion 38B.

Further, a penetration portion (not shown) is formed in a portion and a flange portion 38C on the vehicle upper side of the front side member 22 in the vertical piece portion 38A. These penetration portions are used to attach the front side member 22 to the vehicle body component 16 as will be described later.

The vertical piece portion 38A and the lateral piece portion 38B are formed with a penetration portion (not shown) corresponding to the pop nut. A fastening member (not shown), such as a bolt, is fastened to the pop nut via these penetration portions, whereby the mounting plate 38 is attached to the front side member 22.

On the other hand, the partition wall portion 16D is integrally provided on the front 16D1 of the partition wall portion 16D with a mounting portion 16E to which the mounting plate 38 can be attached. The mounting portion 16E includes a lateral piece portion 16E1 extending in the vehicle widthwise direction along the upper wall portion 22A3 on the vehicle upper side in the end portion 22A. The mounting portion 16E includes a flange portion 16E2 extending from the vehicle width direction outer peripheral edge portion of the lateral piece portion 16E1 toward the vehicle upper side, and a vertical piece portion 16E3. The vertical piece portion 16E3 extends in the vehicle up-down direction along the side wall portion 22A4 on the vehicle width direction inner side of the end portion 22A, and a part thereof extends to the vehicle lower side than the front side member 22.

A penetration portion (not shown) is formed in a portion of the flange portion 16E2 and the vertical piece portion 16E3 on the lower side of the vehicle than the front side member 22.

In the mounting plate 38 and the mounting portion 16E configured as described above, the penetration portion on the vertical piece portion 38A is fastened to the penetration portion on the flange portion 16E2 by fastening members such as bolts and nuts. Further, the penetration portion of the flange portion 38C is fastened to the penetration portion of the vertical piece portion 16E3 by fastening members such as bolts and nuts. As a result, the mounting plate 38 and thus the front side member 22 are attached to the mounting portion 16E.

As also shown in FIG. 3, the front side member 22 is located on the vehicle lower side of the suspension tower 20. A suspension tower 20 is attached to the front side member 22 via an attachment member (not shown).

Although a part of the suspension side rail 24 is bent, the suspension side rail is basically configured in the same manner as the front side member 22. The suspension side rail 24 is attached to the vehicle body component 16 on the vehicle lower side of the front side member 22 in the same manner as the front side member 22.

On the other hand, the “rear surface 16D2” on the vehicle rear side of the partition wall portion 16D is provided with a “lateral rib portion 16F”, a “lateral rib portion 16G”, and a “longitudinal rib portion 16H” as reinforcing rib portions protruding from the rear surface 16D2 toward the vehicle rear side, as shown in FIG. 4. The lateral rib portion 16F, the lateral rib portion 16G, and the longitudinal rib portion 16H extend from the front side member 22 when viewed from the vehicle front-rear direction.

Specifically, the lateral rib portions 16F are located on the outer side in the vehicle width direction of the front side member 22 and extend in the vehicle width direction, and are arranged at intervals in the vehicle vertical direction.

The lateral rib-portions 16G are located between the pair of front side members 22 and extend in the vehicle widthwise direction, and are arranged at intervals in the vehicle vertical direction.

The longitudinal rib portions 16H are located on the vehicle lower side of the front side member 22 and extend in the vehicle vertical direction, and are arranged at intervals in the vehicle widthwise direction.

### Actions and Effects of Embodiment

Next, actions and effects of the embodiment will be described.

In the present embodiment, as shown in FIG. 1 and FIG. 2, the vehicle body 10 includes a vehicle body component 16. The vehicle body component 16 includes an upper component portion 16A extending in the vehicle width direction, a lower component portion 16B extending in the vehicle width direction, and a pair of side component portions 16C connecting the upper component portion 16A and the lower component portion 16B. The vehicle body component 16 has a partition wall portion 16D integrated with the upper component portion 16A, the lower component portion 16B, and the side component portion 16C.

Incidentally, in the vehicle 12 having various specifications, the shape of the windshield glass 29 tends to have the same shape, and the shape of the portion of the vehicle body 10 that supports the windshield glass 29 also tends to be similar. In addition, in vehicles 12 of various specifications, the height and the like of the floor portion of the vehicle body 10 tend to be different, but the correlation between the floor portion of the vehicle body 10 and the portion supporting the floor portion tends to be similar. Also, in vehicles 12 of various specifications, the configuration of the front pillar 10A as a whole tends to differ, but the configuration of the vehicle lower part of the front pillar 10A tends to be similar. Furthermore, in vehicles 12 of various designs, the configuration of the partition partitions separating the vehicle cabin 12A and the power unit room 12B tends to be similar.

Here, in the present embodiment, the upper component portion 16A is capable of supporting the windshield glass 29, and the lower component portion 16B is disposed along the front edge of the floor portion so as to support the floor portion. The side component portion 16C forms part of the underside of the front pillar 10A. The vehicle cabin 12A and the power unit room 12B are partitioned by the partition wall portion 16D. Moreover, a suspension tower 20 that can support a part of a suspension can be attached to the side component portion 16C, the suspension tending to have an attachment position that differs depending on the specifications or the like of the vehicles 12.

That is, in the present embodiment, the parts that can be shared in the vehicle body 10 in the vehicles 12 of various specifications are integrated in the vehicle body component 16. In addition, in the vehicle 12 of various specifications, a portion of the vehicle body 10 that is difficult to be standardized is separate from the vehicle body component 16 and attached to the vehicle body component 16.

Further, in the present embodiment, the vehicle body component 16 is a metallic cast product, and the upper component portion 16A, the lower component portion 16B, the side component portion 16C, and the partition wall portion 16D can be configured as one component. Therefore, the number of parts constituting the vehicle body component 16 can be reduced as compared with a configuration in which the vehicle body component 16 is constituted by the respective steel plates and the like and is welded.

Further, in the present embodiment, as shown in FIG. 4, the partition wall portion 16D is formed with a penetration portion 30 that is penetrated in the vehicle front-rear direction, and the penetration portion 30 is closed by a dash panel component 32. A portion of the brake device 34 is attached to the dash panel component 32.

For this reason, in the present embodiment, the dash panel component 32 provided with the attachment portion corresponding to the attachment position of the brake device 34 is attached to the partition wall portion 16D in accordance with the specifications of the vehicles 12. As a result, a portion of the brake device 34 can be attached to the vehicle body component 16 without changing the shape of the vehicle body component 16.

In the present embodiment, the dash panel component 32 is made of resin. Therefore, by adjusting the resin mold used for manufacturing the dash panel component 32, it is possible to cope with a change in the attachment position of the brake device 34 in the vehicle 12.

In addition, in the present embodiment, as shown in FIG. 1, a front side member 22 extending in the vehicle front-rear direction and attached to the front 16D1 of the vehicle front side of the partition wall portion 16D is provided. The front side member 22 constitutes a part of the skeleton of the vehicle front side of the vehicle body 10. Further, the front side member 22 is located on the vehicle lower side of the suspension tower 20, and can support the suspension tower 20.

By the way, vibration from the suspension side is inputted to the partition wall portion 16D via the suspension tower 20 and the front side member 22, so that it is conceivable that vibration is generated in the partition wall portion 16D.

Here, in the present embodiment, as shown in FIG. 4, the lateral rib portion 16F, the lateral rib portion 16G, and the longitudinal rib portion 16H are formed on the rear surface 16D2 of the partition wall portion 16D on the rear side of the vehicle. The lateral rib portion 16F, the lateral rib portion 16G, and the longitudinal rib portion 16H protrude from the rear surface 16D2 of the partition wall portion 16D toward the vehicle rear side and extend from the front side member 22 when viewed from the vehicle front-rear direction. Therefore, in the present embodiment, it is possible to secure the stiffness of the partition wall portion 16D with respect to various vibrations at the lateral rib portion 16F, the lateral rib portion 16G, and the longitudinal rib portion 16H, and to suppress the vibration of the partition wall portion 16D due to the vibration from the suspension-side.

As described above, according to the vehicle body 10 of the present embodiment, the number of components constituting the vehicle body 10 can be reduced, and the components constituting the vehicle body 10 can be made common.

What is claimed is:

1. A vehicle body comprising:
a vehicle body component being a metal casting, wherein the vehicle body component includes
an upper component portion that extends in a vehicle width direction and supports a windshield glass,
a lower component portion that extends in the vehicle width direction and is arranged along a front edge of a floor portion to support the floor portion,
a pair of side component portions that constitutes a part of a front pillar on a vehicle lower side, the side component portions connecting the upper component portion and the lower component portion, and being each provided with a suspension support portion that supports a part of a suspension, and
a partition wall portion integrated with the upper component portion, the lower component portion, and each of the side component portions, the partition wall portion partitioning a vehicle cabin and a power unit room.

2. The vehicle body according to claim 1,
wherein a penetration portion penetrated in a vehicle front-rear direction is provided on the partition wall portion, and the penetration portion is blocked by a dash panel component, and
wherein a part of a brake device is attached to the dash panel component.

3. The vehicle body according to claim 2, wherein the dash panel component is made of resin.

4. The vehicle body according to claim 1, further comprising a front-rear direction skeleton portion that extends in a vehicle front-rear direction and is attached at a vehicle lower side of the suspension support portion with respect to a front surface of the partition wall portion on a vehicle front side, wherein a reinforcing rib portion is provided on a back surface of the partition wall portion on a vehicle rear side, the reinforcing rib portion protruding from the back surface to the vehicle rear side and extending from the front-rear direction skeleton portion when viewed from the vehicle front-rear direction.
